(19) United States
(12) Patent Application Publication
(10) Pub. No.: US 2002/0153985 A1
(43) Pub. Date: Oct. 24, 2002

(54) Coil and terminal

(76) Inventors: Toru Hirohashi, Minato-ku (JP); Yasuo Yamashita, Minato-ku (JP); Tadashi Sato, Minato-ku (JP); Shinichi Shibakawa, Minato-ku (JP)

Correspondence Address: WENDEROTH, LIND & PONACK, L.L.P., 2033 K STREET N. W., SUITE 800, WASHINGTON, DC, 20006-1021, US

(21) Appl. No.: 10/142,971

(22) Filed: May 13, 2002

Related U.S. Application Data
(62) Division of application No. 09/654,504, filed on Sep. 1, 2000.

(30) Foreign Application Priority Data
Sep. 14, 1999 (JP) 11-259833
Aug. 7, 2000 (JP) 2000-238338

(51) Int. Cl. H01F 27/29

(52) U.S. Cl. 336/192

(57) ABSTRACT

A coil comprises a wire having a predetermined length and a drum core whose s body portion abuts a central area of the wire. The opposite ends of the wire are wound around the body portion of the drum core in mutually opposite directions. The coil is installed in a terminal device formed of at least one main body and at least one terminal element.

This application is a Divisional Application of Ser. No. 09/654,504, filed Sep. 1, 2000.

### BACKGROUND OF THE INVENTION

This invention relates to a coil and a terminal which constitute a winding component such as a choke coil and a transformer.

FIGS. 10A, 10B and 10C are illustrations showing one example of a conventional coil, wherein FIG. 10A is a vertical sectional schematic view of the conventional coil, FIG. 10B is a plan view showing a winding start state of a wire in the conventional coil, and FIG. 10C is a plan view showing a winding end state of the wire in the conventional coil.

FIGS. 11A, 11B and 11C are illustrations showing one example of a conventional terminal, wherein FIG. 11A is a plan view of the conventional terminal, FIG. 11B is a sectional view of the conventional terminal taken on line B-B of FIG. 11A, and FIG. 11C is a front view of the conventional terminal.

FIG. 12 is a perspective view showing another example of a drum core of a conventional coil.

For this type of winding component, heretofore, devices have been widely used in which, as shown in FIGS. 10A-10C, a coil 8 is formed by winding a wire 7 around a drum core 6. Then, as shown in FIGS. 11A-11C, a terminal 1 having two terminal elements 3 embedded in a base seat 2 is prepared. Then, the coil 5 is mounted on a core mounting surface 2e of the base seat 2 of the terminal 1.

However, the above conventional devices have the following inconveniences. Firstly, when the coil 5 is to be formed, one end 7a of the wire 7 serves as a winding start portion and the other end 7b serves as a winding end portion. Accordingly, the wire 7, as shown in FIG. 10B, is wound around the drum core 6 with the first-mentioned end 7a led out from the nearby area of a body portion 6a of the drum core 6 and left extended across the drum core 6 towards an outer edge of a flange portion 6b. As a consequence, a dead space is created around the body portion 6a of the drum core 6 as shown in FIG. 10A and the space factor of the coil 5 is lowered. Accordingly, in order to obtain a predetermined number of turns, the winding width (distance between the two flange portions 6b, 6b) of the drum core 6 must be increased taking this dead space into consideration. As a result, the drum core 6 and thus, the winding component are inevitably increased in thickness.

To avoid such an inconvenience, one possible approach is that a slit 6c, as shown in FIG. 12, is formed in the flange portion 6b of the drum core 6 so that the space factor of the coil can be improved by allowing the winding start portion of the wire (not shown) to escape outside through the slit 6c. However, the technical work for forming such a slit in the drum core 6 is cumbersome and the manufacturing cost is increased. In addition, the winding start position of the wire is limited to the area where the slit is formed. Therefore, this approach is not very practical.

Secondly, since the coil 5, as shown in FIG. 11A, is mounted on the core mounting surface 2e of the base seat 2 of the terminal 1, the total height of the winding component becomes equal to the thickness of the coil 5 plus the height H2 of the core mounting surface 2e. Moreover, since the base seat 2 is required to have a thickness large enough for the terminal elements 3 to be embedded therein, it is rather difficult to design the winding component smaller in height (i.e., having a thinner design).

### SUMMARY OF THE INVENTION

It is, therefore, an object of the present invention to provide, in view of the above situation, a coil in which the height of a winding component can be reduced without sacrificing practical usability thereof.

Another object of the present invention is to provide a new terminal device in which the height of a winding component can be reduced without sacrificing practical usability thereof.

According to one aspect of the present invention, a coil constitutes a winding component, and the coil comprises a wire having a predetermined length. A drum core has a body portion in abutment with a central area of the wire, and opposite ends of the wire are wound around the body portion of the drum core in mutually opposite directions. By virtue of the foregoing construction, the opposite ends of the wire serve as the winding ends and are led out from the nearby area of the outer edge of the flange portion of the drum core. Accordingly, the space factor of the coil can be improved by fully taking advantage of the winding width of the drum core.

According to another aspect of the present invention, there is also provided a terminal device constituting a winding component. The terminal comprises a base seat having a coil retaining space defined therein and which extends vertically therethrough, and comprises a terminal element disposed on the base seat. By virtue of the foregoing construction, only if the coil is properly installed in the coil retaining space and retained, the total height of the winding component coincides with the thickness of the coil and no additional height of the base seat is added thereto.

According to a further aspect of the present invention, there is also provided another terminal device constituting a winding component. The terminal comprises a base seat including a frame-like main body ad a coil insertion hole formed in the main body and extending vertically therethrough. A terminal element is attached to the base seat such that a wrapping portion and a mounting (or packaging) portion of the terminal element project from the main body. By virtue of the foregoing construction, the coil retaining space is defined in the coil insertion hole of the base seat and allowed to extend vertically therethrough. If the coil is properly installed in the coil retaining space and retained, the total height of the winding component coincides with the thickness of the coil and no additional height of the base seat is added thereto.

According to a still further aspect of the present invention, there is also provided another terminal device constituting a winding component. The terminal comprises a base seat including two hat-like (in cross section) main bodies each having a coil clamping wall. The main bodies are connected together to exhibit a square configuration through two terminal elements such that the coil clamping walls are arranged on a concentric circle. The terminal elements each have at an end and a central area thereof a wrapping portion and a mounting (or packaging) portion, respectively. By virtue of the foregoing construction, the coil retaining space is defined in the base seat and allowed to extend vertically therethrough in such a manner as to be surrounded with the coil clamping walls of the base seat. If the coil is properly installed in the coil retaining space and retained, the total height of the winding component coincides with the thickness of the coil and no additional height of the base seat is added thereto.

According to a yet further aspect of the present invention, there is also provided another terminal constituting a winding component. The terminal comprises a base seat including four L-shaped main bodies each having a coil clamping wall. The main bodies are connected together to exhibit a square configuration through four terminal elements such that the coil clamping walls are arranged on a concentric circle. The terminal elements are each provided at an end and a central area thereof with a wrapping portion and a mounting portion, respectively. By virtue of the foregoing construction, the coil retaining space is defined in the base seat and allowed to extend vertically therethrough in such a manner as to be surrounded with the coil clamping walls of the base seat. If the coil is properly installed in the coil retaining space and retained, the total height of the winding component coincides with the thickness of the coil and no additional height of the base seat is added thereto.

According to another feature of the invention, the base seat can be made of a combination of a synthetic resin and a magnetic material so that the base seat is magnetic. This permits the formation of a closed magnetic circuit when the base seat is combined with the coil to reduce an undesirable influence of magnetic flux leakage of the coil.

### BRIEF DESCRIPTION OF THE DRAWINGS

FIGS. 1A, 1B and 1C are illustrations showing one embodiment of a coil according to the present invention, wherein FIG. 1A is a vertical sectional schematic view, FIG. 1B is a plan view showing a winding start state of a wire, and FIG. 1C is a plan view showing a winding end state of a wire;

FIGS. 2A, 2B and 2C are illustrations showing a first embodiment of a terminal according to the present invention, wherein FIG. 2A is a plan view, FIG. 2B is a right side view, and FIG. 2C is a front view;

FIGS. 3A, 3B and 3C are illustrations showing a second embodiment of a terminal according to the present invention, wherein FIG. 3A is a plan view, FIG. 3B is a right side view, and FIG. 3C is a front view;

FIGS. 4A, 4B and 4C are illustrations showing a third embodiment of a terminal according to the present invention, wherein FIG. 4A is a plan view, FIG. 4B is a right side view, and FIG. 4C is a front view;

FIGS. 5A and 5B are illustrations showing a fourth embodiment of a terminal according to the present invention, wherein FIG. 5A is a plan view, and FIG. 5B is a right side view;

FIG. 6 is a plan view showing a fifth embodiment of a terminal according to the present invention;

FIG. 7 is a plan view showing a sixth embodiment of a terminal according to the present invention;

FIG. 8A is a diagram showing a magnetic path when the base seat is made of a material which contains magnetic material;

FIG. 8B is a diagram showing a magnetic path when the base seat is made of a material which contains no magnetic material;

FIG. 9 is a graph showing a relation between a bias current and its inductance (L) of a coil component;

FIGS. 10A, 10B and 10C are illustrations showing one example of a conventional coil, wherein FIG. 10A is a vertical sectional schematic view, FIG. 10B is a plan view showing a winding start state of a wire, and FIG. 10C is a plan view showing a end state a wire;

FIG. 11A, 11B and 11C are illustrations showing one example of a conventional terminal, FIG. 11A is a plan view, FIG. 11B is a sectional view taken on line B-B of FIG. 11A, and FIG. 11C is a front view; and

FIG. 12 is a perspective view showing another example of a drum core of a conventional coil.

### DETAILED DESCRIPTION OF THE EMBODIMENTS

Several embodiments of the present invention will now be described with reference to the accompanying drawings.

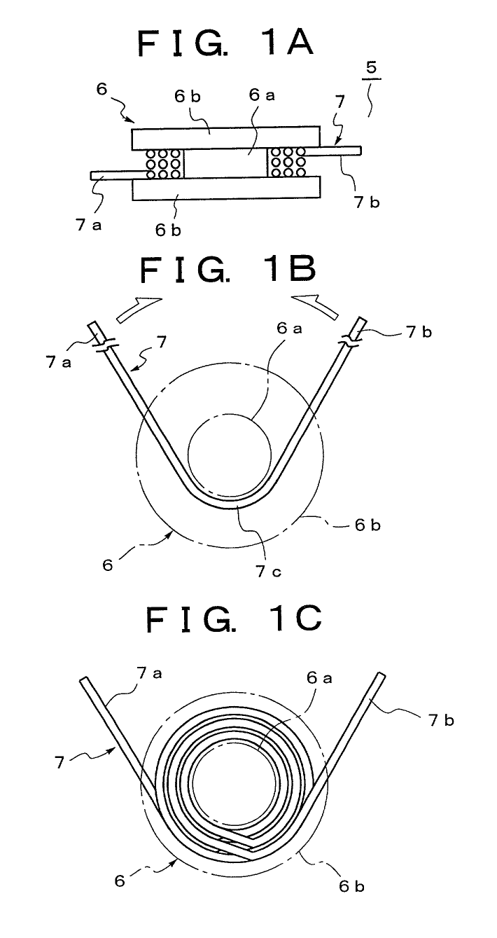

Referring first to FIGS. 1A-1C, a coil 5 is comprised of a ferrite drum core 6 and a wire 7. The drum core 6 includes a circular column-like (cylindrical) body portion 6a. A disc-like flange portion 6b is formed on each of upper and lower sides of the drum core 6. The wire 7 is wound around the body portion 6a of the drum core 6 in an orderly arranged manner. Opposite ends 7a, 7b of the wire 7 are led out in a tangential direction from the nearby area of an outer edge of the flange portion 6b.

In other words, when the wire 7 is to be wound, the wire having a required length is prepared. Then, as shown in FIG. 1B, a central portion 7c of the wire 7 is arranged so as to abut the body portion 6a of the drum core 6, and the opposite ends 7a, 7b of the wire 7 are wound around the body portion 6a of the drum core 6 in mutually opposite directions (one end 7a in a clockwise direction and the other in a counterclockwise direction). Then, the winding of the wire 7 is finished in a state in which the central portion 7c of the wire 7 serves as the winding start portion and the opposite ends 7a, 7b serve as the winding end portions. The wire 7, as shown in FIG. 1C, is led out in the tangential direction from the nearby area of the outer edge of the flange portion 6b of the drum core 6. Thus, as shown in FIG. 1A, the wire is wrapped around the entire circumferential surface of the body portion 6a.

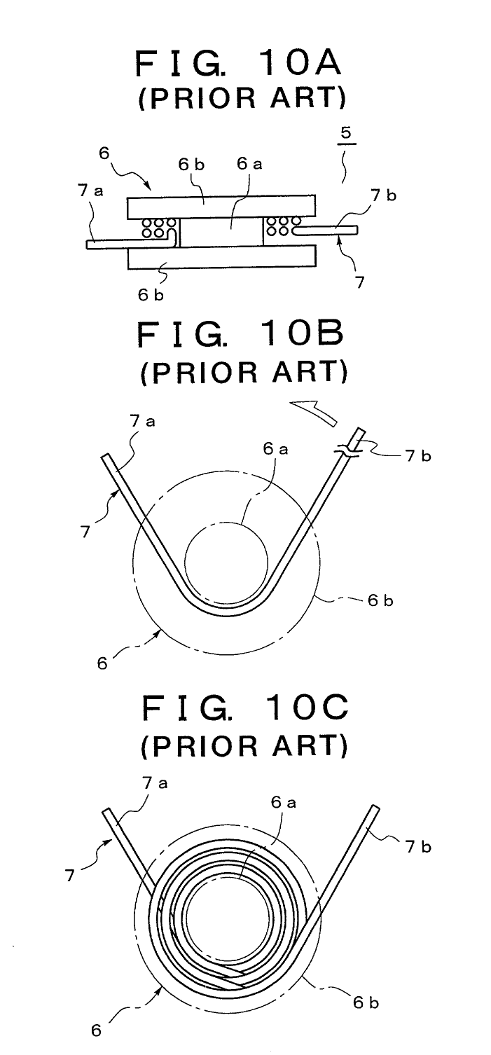

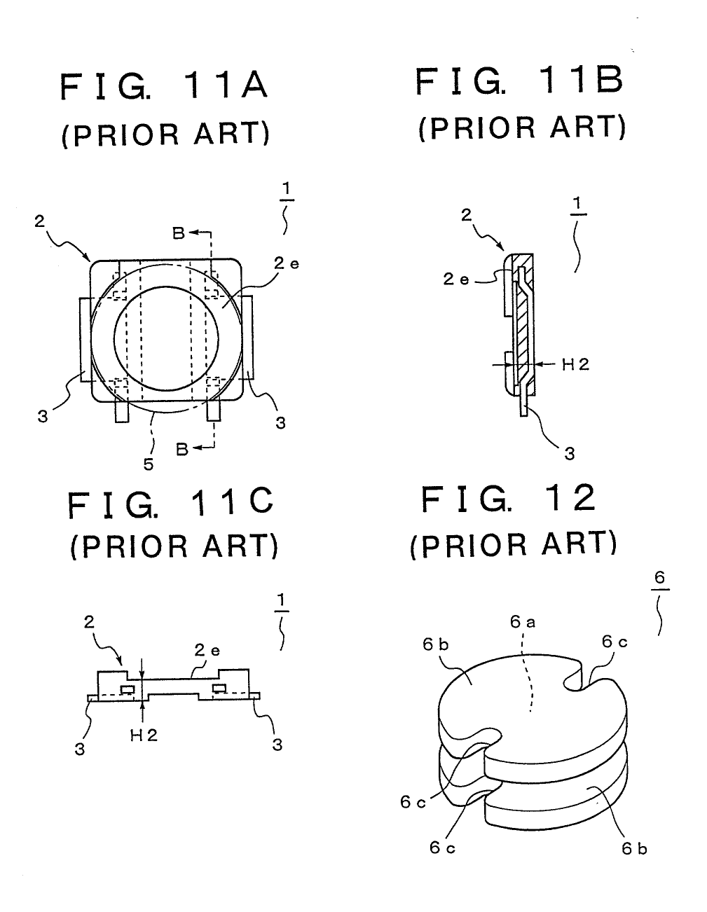

As a result, as shown in FIG. 1A, no dead (empty) space is created around the body portion 6a of the drum core 6 and the winding width of the drum core 6 can fully be utilized. Accordingly, the space factor of the coil 5 can be improved and the drum core 6 can be designed thinner compared with the conventional coil (see FIGS. 10A to 10C) in which a dead space is inevitably created. Thus, a coil 5 of a thinner design can be obtained.

In the above embodiment, there has been described a coil 5 formed by winding the wire 7 around the drum core 6 in an orderly arranged manner. It should be noted, however, that the method for winding the wire 7 is not limited to this and any other appropriate winding method may be employed, such as, for example, random winding (rough winding).

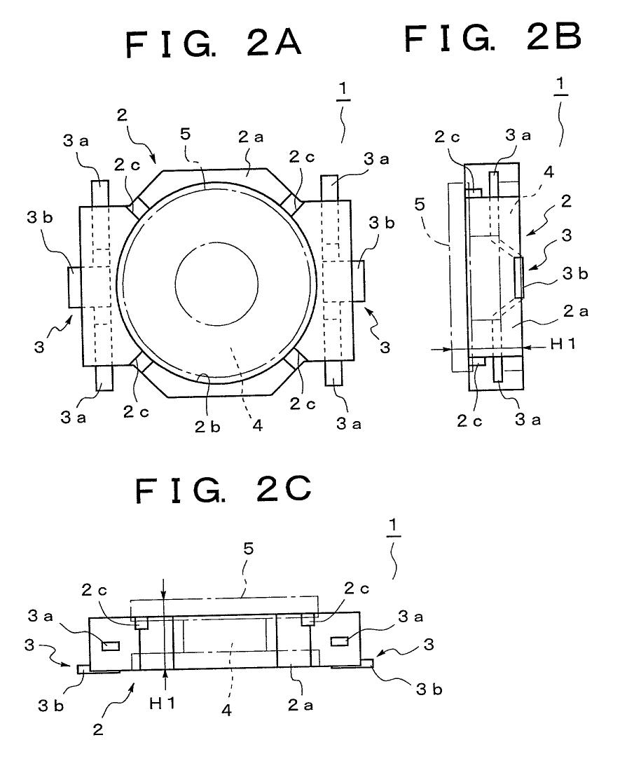

FIGS. 2A to 2C show a first embodiment of a terminal device according to the present invention. The terminal 1 is comprised of a synthetic resin base seat 2 and two terminal elements 3. The base seat 2 includes a frame-like main body 2a. A circular coil insertion hole 2b is formed in a central area of the base seat 2a in such a manner as to define a coil retaining space 4 therein and extend vertically therethrough. Four guide grooves 2c are formed in a periphery of the coil insertion hole 2b. On the other hand, the two terminal elements 3, as shown in FIG. 2A, are embedded in opposite left and right sides of the coil insertion hole 2b of the base seat 2. Each terminal element 3 has two wrapping portions 3a and two mounting portions 3b projecting from the main body 2a of the base seat 2.

When a winding component is to be constituted by combining the coil 5 with the terminal 1, as shown in FIG. 2A, the coil 5 is inserted into the coil retaining space 4 of the terminal 1, and the coil 5 is affixed to the base seat 2 by adhesive agent (not shown). Thereafter, the opposite ends 7a, 7b of the wire 7 on the coil 5 are led out along the guide groove 2c of the base seat 2 so as to be wrapped over the wrapping portion 3a for soldering. At that time, as shown in FIGS. 2B and 2C, a lower surface of the drum core 6 of the coil 5 coincides with a bottom surface of the base seat 2 of the terminal 1. Then, the total height of the winding component, which is comprised of the coil 5 and the terminal 1, becomes equal to the thickness H1 of the coil 5. Although the mounting portion 3b of each terminal element 3 is situated lower than the bottom surface of the base seat 2, this difference is negligibly small. Moreover, as previously described, since the drum core 6 is of a thinner design, the overall height of the winding component can be reduced. Since a normal drum core having a flange portion with no slit formed therein is used as the drum core 6 in this embodiment, there is no fear that the practical usability of the coil 5 will be lowered due to an increase in manufacturing cost and limitation of the winding start position of the wire 7.

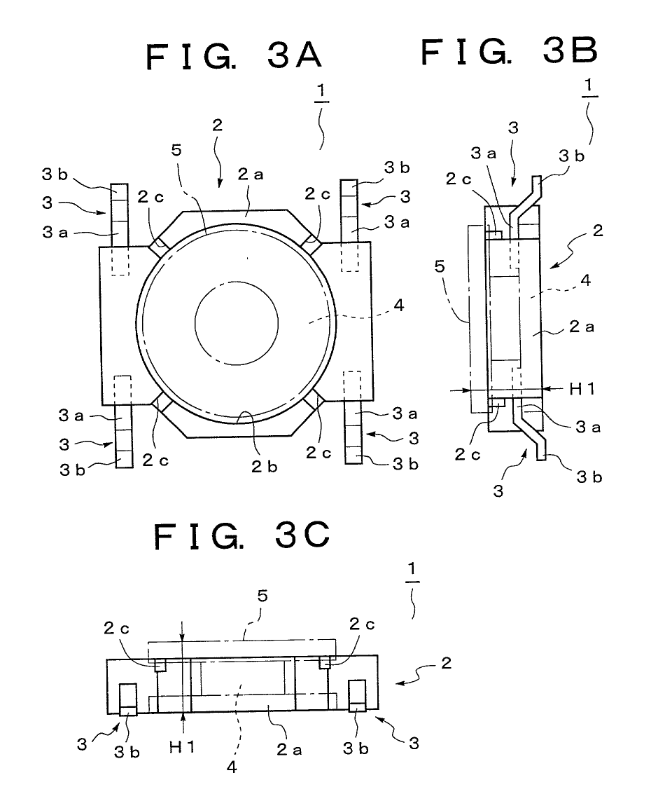

Although there has been described, in the above embodiment, the terminal 1 having two terminal elements 3 bent into a crank-like configuration, the configuration and number of terminal elements 3 are not limited to the above, and many other variations can be contemplated. For example, as shown in FIGS. 3A to 3C, four terminals 3 each formed in an S-shaped configuration may be employed. In the event where four such terminals 3 are employed, only a basal portion and a distal end portion of the overall projecting portion of each terminal element 3 which projects from the base seat 2 may be provided with the wrapping portion 3a and the mounting (or packaging) portion 3b, respectively.

Moreover, in the above embodiment, only one main body 2a constituting the base seat 2 is employed. It should be noted, however, that the number of the main body 2a is not limited to one, and a base seat 2 having a plurality of main bodies 2 may be employed.

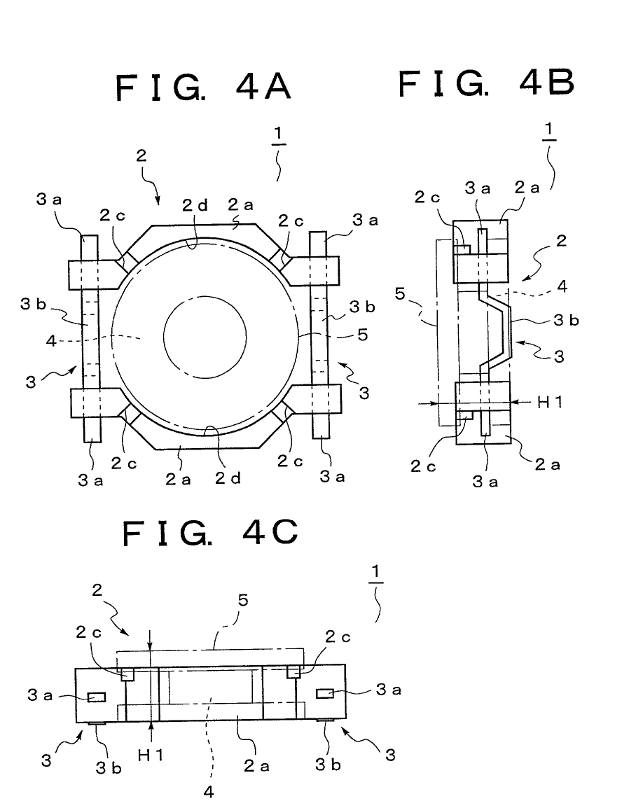

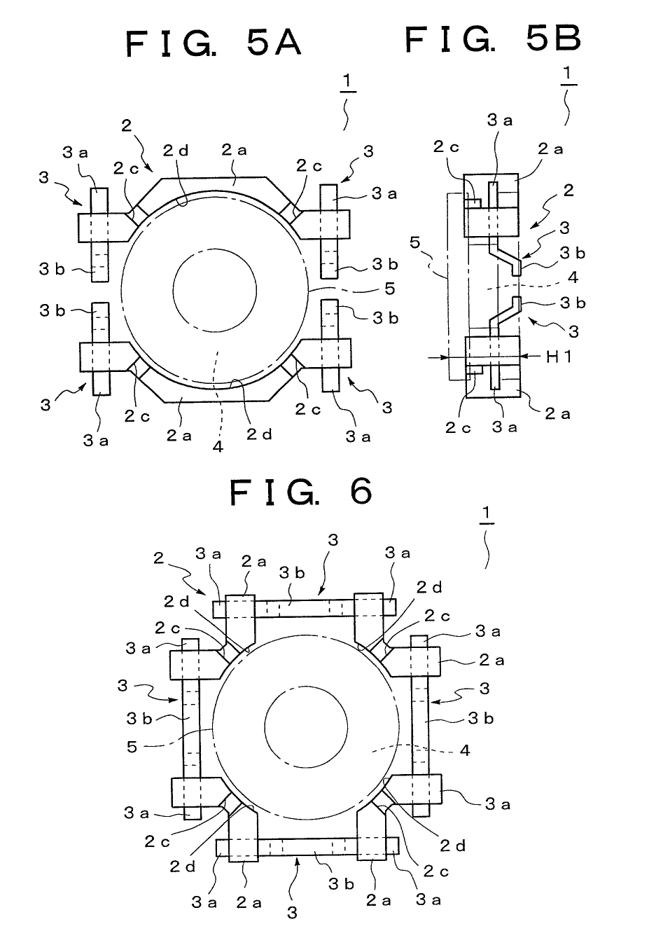

For example, as shown in FIGS. 4A to 4C, it is accepted that a base seat 2 having two main bodies 2a each formed in a hat-like configuration (in cross section) is employed, and those base bodies 2a are connected together to exhibit a square configuration through two terminal elements 3, thereby constituting the terminal 1. In the event where such a variation is employed, an arcuate coil clamping wall 2d is formed in an inner peripheral surface of each of the main bodies 2a on a concentric circle. By doing so, the coil retaining space 4 can be formed in such a manner as to be bracketed by the coil retaining wall 2d. Moreover, the main body 2a, when compared with the base seat 2 (see FIGS. 2A to 2C and FIGS. 3A to 3C) in which the circular coil insertion hole 2b must be formed in the main body 2a, is simplified in configuration and provides a favorable workability. The central area of each terminal element 3 is not embedded in the base seat 2. By forming the mounting portion 3b on this central area and forming a wrapping portion 3a on each of the opposite ends of each terminal element 3, the width (vertical length in FIG. 4A) of the terminal 1 can be reduced compared with the terminal 1 shown in FIGS. 3A to 3C, thus achieving a downsizing of the terminal. Moreover, by cutting the central portion of each terminal element 3 after the coil 5 is inserted into the coil retaining hole 4 of the terminal 1 and adhered thereto as shown in FIGS. 5A and 5B, the number of the terminal elements 3 can be doubled from two to four.

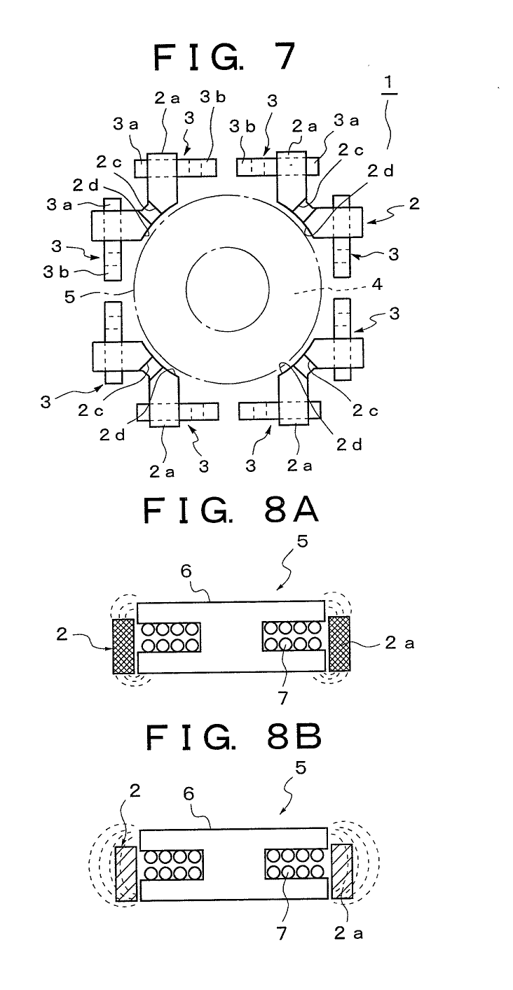

It is also accepted that a base seat 2, as shown in FIG. 6, having four main bodies 2a each formed in an L-shaped configuration can be employed and those main bodies 2a are connected together to exhibit a square configuration through four terminal elements 3, thereby constituting the terminal 1. In the event where this modification is employed, an arcuatecoil clamping wall 2d is formed in an inner peripheral surface of each of the main bodies 2a on a concentric circle. By doing so, the coil retaining space 4 can be formed in such a manner as to be surrounded with the coil retaining wall 2d. Moreover, the main body 2a, when compared with the base seat 2 (see FIGS. 2A-2B and FIGS. 3A-3C) in which the circular coil insertion hole 2b must be formed in the main body 2a, is simplified in configuration and provides a favorable workability. Since the central area of each terminal element 3 is not embedded in the base seat 2, it becomes possible to form the mounting portion 3b on this central area and the wrapping portion 3a on each of the opposite ends of each terminal element 3. Moreover, by cutting the central portion of each terminal element 3 after the coil 5 is inserted into the coil retaining hole 4 of the terminal 1 and adhered thereto as shown in FIG. 7, the number of terminal elements 3 can be increased from four to eight.

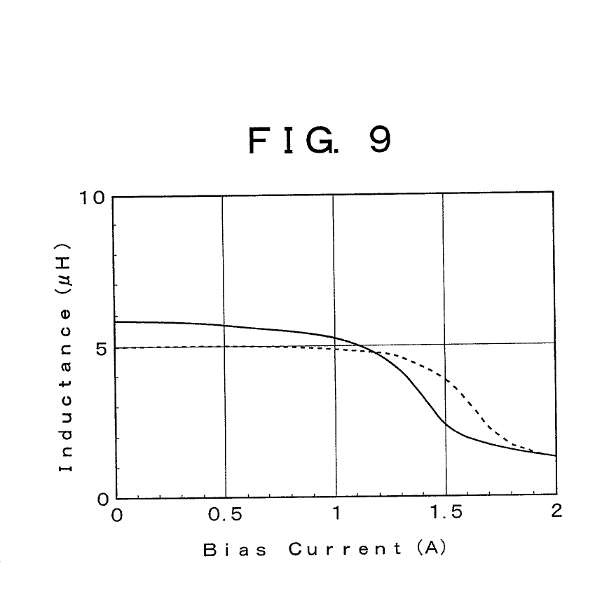

Although the description has been made with reference to the preferred embodiment in which the base seat 2 of the terminal is made of a suitable synthetic resin so that the base seat 2 is non-magnetic, the base seat 2 can be made of a mixture of a magnetic material such as ferrite or iron powder and a synthetic resin so that the entire structure of the base seat is magnetic. This will be advantageous from a view point of electromagnetic properties. Namely, in FIGS. 8A, 8B and 9, if the base seat 2 which is made of the material containing a magnetic material is used with a coil or coils 5, a closed magnetic circuit is formed by the combination of a flange portion 6b of a drum core 6 of the coil 5 and the base seat 2. Thus, when a coil or winding device is formed by assembling the coil 5 into the terminal 1, there is less influence of magnetic leakage of the coil 5, with the result of an increase in inductance (L). For comparison, FIG. 8B shows a case in which the base seat 2 is made of a synthetic resin with no magnetic material contained therein.

FIG. 9 shows the difference in inductance (L) between the base seat of FIG. 8A, which contains a magnetic material, and the base seat of FIG.-8B, which does not contain a magnetic material. As shown in FIG. 9, in the region where a bias current is 1.2 A or less, the base seat which contains the magnetic material exhibited a larger inductance (L) as shown by a solid line relative to a smaller inductance as shown by a dotted line.

As described hereinbefore, a coil according to the present invention comprises a wire 7 having a predetermined length and a drum core 6 whose body portion 6a is in abutment with a central area 7c of the wire 7. Opposite ends 7a, 7b of the wire 7 are wound around the body portion 6a of the drum core 6 in mutually opposite directions. By virtue of the foregoing construction, the opposite ends 7a, 7b of the wire 7 serve as the winding ends and are led out from the nearby area of the outer edge of the flange portion 6b of the drum core 6. Accordingly, the space factor of the coil 5 can be improved by fully taking advantage of the winding width of the drum core 6. Thus, there can be provided a coil 5 in which the height of the winding component can be reduced without sacrificing practical usability thereof.

A terminal device according to another aspect of the present invention comprises a base seat 2 having a coil retaining space 4 defined therein and extending vertically therethrough and a terminal element 3 disposed on the base seat 2. By virtue of the foregoing construction, if the coil 5 is properly installed in the coil retaining space 4 and retained, the total height of the winding component coincides with the thickness H1 of the coil 5 and no additional height of the base seat 2 is required or added thereto. Thus, there can be provided a terminal device 1 in which the height of the winding component can be reduced without sacrificing practical usability thereof.

A terminal according to a further aspect of the present invention comprises a base seat 2 including a frame-like main body 2a and a coil insertion hole 2b formed in the main body 2a and extending vertically therethrough. A terminal element 3 is attached to the base seat 2 such that a wrapping portion 3a and a mounting portion 3b of the terminal element 3 project from the main body 2a. By virtue of the foregoing construction, the coil retaining space 4 is defined in the coil insertion hole 2b of the base seat 2 and allowed to extend vertically therethrough. If the coil 5 is properly installed in the coil retaining space 4 and retained there, the total height of the winding component coincides with the thickness H1 of the coil 5 and no additional height of the base seat 2 is required or added thereto. Thus, it is possible to provide a terminal device 1 in which the height of the winding component can be reduced without sacrificing practical usability thereof.

A terminal device according to a still further aspect of the present invention comprises a base seat 2 including two hat-like main bodies 2a each having a coil clamping wall 2b. The main bodies 2a are connected together to exhibit a square configuration through two terminal elements 3 such that the coil clamping walls 2d are arranged on a concentric circle. The terminal elements 3 are each provided at an end and a central area thereof with a wrapping portion 3a and a mounting portion 3b, respectively. By virtue of the foregoing construction, the coil retaining space 4 is defined in the base seat 2 and allowed to extend vertically therethrough in such a manner as to be surrounded with the coil clamping walls 2d of the base seat 2. If the coil 5 is properly installed in the coil retaining space 4 and retained there, the total height of the winding component coincides with the thickness H1 of the coil 5 and no additional height of the base seat 2 is added thereto. Thus, there can be provided a terminal 1 in which the height of the winding component can be reduced without sacrificing practical usability thereof.

A terminal device according to a yet further aspect of the present invention comprises a base seat 2 including four L-shaped main bodies 2a each having a coil clamping wall 2b. The main bodies 2a are connected together to exhibit a square configuration through four terminal elements 3 such that the coil clamping walls 2d are arranged on a concentric circle. The terminal elements 3 are each provided at an end and a central area thereof with a wrapping portion 3a and a mounting portion 3b, respectively. By virtue of the foregoing construction, the coil retaining space 4 is defined in the base seat 2 and allowed to extend vertically therethrough in such a manner as to be surrounded with the coil clamping walls 2d of the base seat 2. If the coil 5 is properly installed in the coil retaining space 4 and retained there, the total height of the winding component coincides with the thickness H1 of the coil 5 and no additional height of the base seat 2 is added thereto.

Further, if the base seat is made of a magnetic material or a material which contains a magnetic material so that the base seat is magnetic, a closed magnetic circuit is formed between the coil 5 and the base seat 2. If the base seat 2 is coupled with the coil 5, a leakage of a magnetic flux of the coil 5 can be reduced effectively so that it is possible to increase an inductance.

We claim:

1. An apparatus comprising:
a drum core having a body portion;
a wire wrapped around an entire circumferential surface of said body portion of said drum core so as to form a coil; and
a terminal device including:
a base seat having a coil retaining space formed therein, said coil being arranged in said coil retaining space and fixed to said base seat; and
a terminal element connected to said base seat.

2. The apparatus of claim 1, wherein said base seat comprises at least one main body arranged so as to form said coil retaining space, said terminal element having at least one wrapping portion and a mounting portion, and an end of said wire being wrapped around a respective one of said at least one wrapping portion.

3. The apparatus of claim 2, wherein each of said at least one main body includes at least one guide groove, each of a pair of opposite ends of said wire extending through a respective one of said at least one guide groove from an interior of said base seat to an exterior of said base seat, said at least one wrapping portion being located at said exterior of said base seat.

4. The apparatus of claim 1, wherein said base seat comprises a pair of main bodies arranged so as to form said coil retaining space, said terminal element comprising a first terminal element, further comprising a second terminal element, said first terminal element and said second terminal element being arranged so as to connect said pair of main bodies.

5. The apparatus of claim 4, wherein said first terminal element has at least one wrapping portion and a mounting portion, and wherein said second terminal element has at least one wrapping portion and a mounting portion.

6. The apparatus of claim 5, wherein each of said pair of main bodies includes at least one guide groove, each of a pair of opposite ends of said wire extending through a respective one of said at least one guide groove from an interior of said base seat to an exterior of said base seat, said at least one wrapping portion of each of said first terminal element and said second terminal element being located at said exterior of said base seat, each of said pair of opposite ends of said wire being wrapped around a respective one of said wrapping portions.

7. The apparatus of claim 1, wherein said base seat comprises four L-shaped main bodies arranged so as to form said coil retaining space, each of said four L-shaped main bodies having a respective terminal element, each terminal element having at least one wrapping portion and a mounting portion.

8. The apparatus of claim 1, wherein said base seat comprises a magnetic material.

9. The apparatus of claim 1, wherein a central portion of said wire abuts said body portion.

10. The apparatus of claim 1, wherein said drum core comprises a ferrite drum core.

11. The apparatus of claim 1, wherein said body portion is cylindrical, said drum core further having a disc-shaped flange on each end of said cylindrical body portion.

12. The apparatus of claim 1, wherein said disc-shaped flange on each end of said cylindrical body portion comprises a solid disc-shaped flange free of radial slits.

13. A terminal device comprising:
a base seat having a coil retaining space formed therein, a wire coil being arranged in said coil retaining space and fixed to said base seat; and
a terminal element connected to said base seat.

14. The terminal device of claim 13, wherein said base seat comprises at least one main body arranged so as to form said coil retaining space, said terminal element having at least one wrapping portion and a mounting portion, wherein the coil is wrapped around a respective one of said at least one wrapping portion.

15. The terminal device of claim 14, wherein each of said at least one main body includes at least one guide groove such that each of a pair of opposite ends of a wire forming the wire coil extends through a respective one of said at least one guide groove from an interior of said base seat to an exterior of said base seat, said at least one wrapping portion being located at said exterior of said base seat.

16. The terminal device of claim 13, wherein said base seat comprises a pair of main bodies arranged so as to form said coil retaining space, said terminal element comprising a first terminal element, further comprising a second terminal element, said first terminal element and said second terminal element being arranged so as to connect said pair of main bodies.

17. The terminal device of claim 16, wherein said first terminal element has at least one wrapping portion and a mounting portion, and wherein said second terminal element has at least one wrapping portion and a mounting portion.

18. The terminal device of claim 17, wherein each of said pair of main bodies includes at least one guide groove such that each of a pair of opposite ends of a wire forming the wire coil extends through a respective one of said at least one guide groove from an interior of said base seat to an exterior of said base seat, said at least one wrapping portion of each of said first terminal element and said second terminal element being located at said exterior of said base seat so that each of the pair of opposite ends of the wire are wrapped around a respective one of said wrapping portions.

19. The terminal device of claim 13, wherein said base seat comprises four L-shaped main bodies arranged so as to form said coil retaining space, each of said four L-shaped main bodies having a respective terminal element, each terminal element having at least one wrapping portion and a mounting portion.

20. The terminal device of claim 13, wherein said base seat comprises a magnetic material.
